(19) United States
(12) Patent Application Publication
(10) Pub. No.: US 2014/0116192 A1
(43) Pub. Date: May 1, 2014

(54) LIGHTER PEDAL ASSEMBLY REINFORCED WITH RESPECT TO OFFSET DRIVING FORCES

(71) Applicant: MGI COUTIER, Champfromier (FR)

(72) Inventors: Pavan HEMMEGE VENKATAPPA, Conde sur Noireau (FR); Eric FERRETTE, Laize la Ville (FR); Jacques GUEVEL BADOU, Falaise (FR)

(73) Assignee: MGI COUTIER, Champfromier (FR)

(21) Appl. No.: 14/014,447

(22) Filed: Aug. 30, 2013

(30) Foreign Application Priority Data
Aug. 31, 2012 (FR) 12/58163

(51) Int. Cl. G05G 1/44

(52) U.S. Cl. CPC G05G 1/44
USPC 74/512

(57) ABSTRACT

The invention relates to a pedal assembly (1) comprising a base (2) provided with at least one fastening member (3) designed to allow said base to be fastened the floor of a vehicle (4), as well as at least one pedal (6) having an arm (7) that is articulated on said base (2) around a tilting axis (XX′) supported by said base, the base including, between the fastening member (3) and the tilting axis (XX′), a hollow barrel segment (11) created along a main axis (ZZ′) oriented substantially from said fastening member toward said tilting axis (XX′), and the wall (12) of which forms, in transverse cross-section relative to the main axis (ZZ′), a closed contour around said main axis (ZZ′), and in that the arm (7) of the pedal is subdivided into two branches (14, 15) forming a yoke (16) that is articulated around the tilting axis (XX′) outside the wall (12) of said barrel segment (11).

### TECHNICAL FIELD

The present invention relates to the general field of control pedal assemblies, for example to equip motor vehicles, to allow a user, and more particularly a driver, to control any function, such as accelerating, de-clutching or braking.

### BACKGROUND

Many types of pedal assemblies are already known, in particular brake pedal assemblies.

Generally, such pedal assemblies comprise a base on which at least one pedal arm is articulated, said arm being arranged to transmit a control force exerted by the user's foot to an actuator, for example such as a clutch cable or a brake rod.

Due in particular to the intensity and the repeated nature of the stresses that these pedal assemblies must undergo, the latter must have particularly robust structures, for example comprising a base of the framework type inside which the pedal arm is engaged, as illustrated document DE-10 2007 059 376.

In fact, such structures are also relatively massive, heavy and bulky, which is counter to the now-constant desire of automobile builders to make vehicles, and consequently their various component parts, lighter.

Furthermore, the complexity of the known pedal assemblies may make their manufacture and assembly long and costly.

### BRIEF SUMMARY

The invention therefore aims to resolve the aforementioned drawbacks and propose a new type of pedal assembly that reconciles considerable robustness with a simple, compact and light structure.

The aims of the invention are achieved using a pedal assembly comprising a base provided with at least one fastening member designed to allow said base to be fastened on a receiving support, such as the fire wall of a vehicle, as well as at least one pedal having an arm that is articulated on said base around a tilting axis supported by said base, said pedal assembly being characterized in that the base includes, between said at least one fastening member and the tilting axis, a hollow barrel segment created along a main axis oriented substantially from said fastening member toward said tilting axis, the wall of the barrel segment forming, in transverse cross-section relative to the main axis, a closed contour around the main axis, and in that the arm of the pedal comprises two branches forming a yoke that is articulated around the tilting axis outside the wall of said barrel segment.

Advantageously, by equipping the arm with a forked structure, comprising an articulation yoke that extends laterally, along the tilting axis, overhanging at least part of the wall forming the support structure of the base, said base thus being placed between the branches of said yoke, the invention makes it possible to increase the extent, and consequently the precision, mechanical strength and stability, of the corresponding pivot link.

By spreading said pivot link axially, the invention in fact procures improved guidance, in particular by making it possible, with equal operating clearance in the pivot link, to significantly reduce the lateral travel of the arm compared to a traditional single-branch connection, in particular at the end of the arm of the pedal, where the driver's foot presses. The comfort, precision and feeling of control are thereby improved.

The invention also makes it possible to increase the contact surfaces supporting the articulation, which consolidates said pivot link, in particular with respect to the shearing forces exerted by the arm transversely to the tilting axis and/or torsion forces exerted around the main axis.

Aside from the robustness imparted to the pivot link strictly speaking, the arrangement of the pedal assembly according to the invention also makes it possible, if needed, to widen the body of the arm of the pedal, beyond the yoke, if applicable over the entire length of the said arm. It therefore becomes possible to adapt and improve the intrinsic strength of said arm to withstand torsion (in terms of roll relative to the longitudinal direction of said arm) and/or lateral bending (yaw), while preserving a base that may continue to have a moderate bulk.

The mechanical features of the pedal assembly may thus be significantly strengthened, in particular against the stresses generated by the application of offset control forces, i.e., forces applied outside the median plane of the arm, while nevertheless preserving a pedal assembly structure that is generally light and compact.

Additionally, the same standard base model may, if applicable, alternatively be associated with different arms, in particular having variable widths selected as a function of the intended use of the pedal. Such configurability therefore advantageously makes the invention quite versatile.

Furthermore, the use of a hollow barrel segment, of the tubular mast type, to support the pedal while providing the link between the tilting axis and the fastening members, makes it possible to benefit from a structure that is both light, because it is hollow, and strong.

Indeed, such a barrel segment first has excellent torsion resistance, around its main axis, owing to its wall, which forms a section closed on itself around the said axis, and consequently gives to the barrel segment a high torsional moment of inertia in the planes normal to the torsional moments.

Furthermore, such a barrel segment forms a mast whereof the solid peripheral walls, generated along the main axis, which is preferably substantially rectilinear and preferably substantially normal to the support to which the base is fastened, are advantageously oriented substantially in the foreseeable direction of the reaction that the base exerts on the arm when the latter is subject to the combined biases of the control force (pushing in the pedal) and the actuating force, and more particularly compression force, on the actuator (brake rod).

As a result, said barrel segment may, despite the lightness of its hollowed out structure, advantageously assume the role of a tie rod, able to effectively withstand the aforementioned reaction force, which essentially biases it in traction along its main axis.

By combining the aforementioned structural optimizations, the invention therefore advantageously makes it possible to obtain a pedal assembly, in particular a brake pedal assembly, that not only has excellent mechanical strength, and therefore good longevity, but also particularly precise and reliable operation, while having a light, very “lightened” structure, that uses a minimal quantity of material and may additionally be made from a light, cost-effective and easily transformable material, such as a thermoplastic polymer.

To that end, it will be noted that the hollow tubular structure of the base, oriented according to the invention, as well as the structure of the pedal advantageously make it possible to consider manufacturing those elements simply and inexpensively by molding, in particular by injection molding, using relatively simple tools.

According to other optional embodiments of the invention:
the barrel segment extends over at least 50%, at least 75%, or even over all of the portion of the base comprised between the tilting axis and the fastening member furthest therefrom;
the base comprises a plurality of peripheral fastening members distributed around the barrel segment, radially beyond the inner cavity delimited by the wall of said barrel segment, on a base plate transverse to the main axis;
the base includes at least one central fastening member situated in the inner cavity delimited by the wall of the barrel section and/or in the extension of said inner cavity;
the central fastening member is designed to allow the base to be securely fastened to the receiving support, preferably by an anchoring screw, while the peripheral fastening members are formed by one or more pins or crosses, and/or one or more bushings designed to cooperate with centering pins rising on the receiving support, so as to position the base regularly relative to the receiving support and block the azimuth rotation of said base around its main axis;
the base, and preferably the barrel segment, has a transverse section that increases going from the tilting axis toward the fastening member(s);
the barrel segment has an inner narrowing that marks an overthickness of the wall of said barrel segment and that is pierced all the way through so as to form a bearing for the tilting axis;
projected in a plane normal to the tilting axis, at least one fastening member is positioned substantially in the axial extension of the barrel segment, offset relative to the tilting axis, either toward the arm or at the opposite from said arm, such that the force line passing through said fastening member and said tilting axis substantially follows the orientation of the foreseeable reaction of the base to the foreseeable control forces, to be exerted by the user on the arm, and to the foreseeable actuating forces, to be exerted by the arm on an actuator of the brake control rod type, to which said arm is designed to be connected;
each branch of the yoke has a protuberance oriented toward the inside of said yoke to form a joint bearing around the tilting axis, and in that each of the left and right outer side portions of the wall of the barrel segment is hollowed out with a slot arranged to pass through the tilting axis and emerge on at least one of the faces, preferably the front face, of the barrel segment, so as to be able to receive the corresponding protuberance of the yoke and guide it to said tilting axis during mounting of the pedal on the base;
the base and/or the pedal are made integrally, and preferably in a single piece, from a material that can be injection molded;
the material that can be injection molded is selected from among: a thermoplastic polymer, a composite material having a matrix made from a plastic and that may or may not be reinforced by woven or not woven fibers, and an aluminum- or magnesium-based metal alloy;
the pedal assembly is made in whole or in part, and preferably in that the base and/or the pedal are made, by assembling sheets of aluminum or steel, or rigid plates of composite materials having a matrix made from plastic.

Furthermore, the present invention relates to a vehicle, in particular a motor vehicle, equipped with a pedal assembly according to the invention.

### BRIEF DESCRIPTION OF THE DRAWINGS

Other aims, features and advantages of the invention will appear in more detail upon reading the following description, and using the appended drawings, provided purely as an illustration and non-limitingly, in which:

FIG. 1 shows an overall perspective view of one embodiment of a pedal assembly according to the invention.

FIG. 2 shows a top view of the pedal assembly of FIG. 1.

FIG. 3 shows a side view of the pedal assembly of FIGS. 1 and 2 accompanied by a diagram of the forces exerted on the arm of the pedal during actuation thereof.

FIG. 4 illustrates a perspective view of one example of a forked pedal belonging to the pedal assembly of FIGS. 1 to 3.

FIG. 5 illustrates a perspective view of the tubular base that equips the pedal assembly of FIGS. 1 to 3.

FIG. 6 illustrates the base of FIG. 5 in top view, projected in a plane normal to the main axis.

FIG. 7B illustrates the base of FIGS. 5 and 6, in frontal cross-section along the broken cutting line indicated in FIG. 7A, which successively passes through the main axis, then the tilting axis.

FIGS. 8, 9 and 10 are cross-sectional views of the barrel segment of the base of FIGS. 5 to 7, taken successively along the main axis.

FIGS. 11 and 12 show, in perspective view and frontal cross-sectional view along a broken line similar to that of FIG. 7A, respectively, a second alternative of a base according to the invention.

FIGS. 13 and 14 show, in perspective view and dorsal cross-sectional view along a broken line similar to that of FIG. 7A, respectively, a third alternative of a base according to the invention.

### DETAILED DESCRIPTION

The present invention relates to a pedal assembly 1, of the control pedal assembly type designed to actuate any mechanism, and more particularly a pedal assembly designed to be installed in a vehicle, in particular a motor vehicle, so as to be able to manage an acceleration, clutch and/or braking control, which is optionally power-assisted.

The present invention also relates to a vehicle (not shown), and in particular a motor vehicle, preferably with wheels, designed for example for individual or group transport of people or goods, that is equipped with a pedal assembly 1 according to the invention.

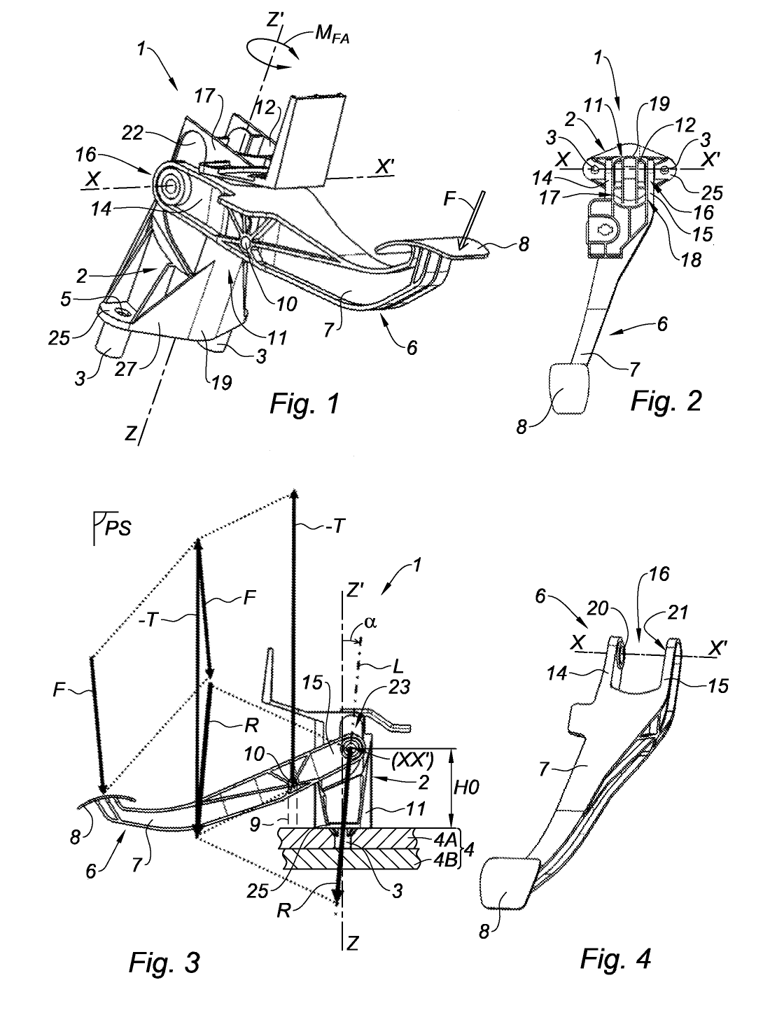

As in particular illustrated in FIGS. 1 to 3, the pedal assembly 1 comprises a base 2 provided with at least one fastening member 3 designed to allow said base 2 to be fastened on the receiving support 4, such as the floor, or more preferably the fire wall 4B, of a vehicle.

Preferably, the fastening member(s) 3 are formed by one or more feet protruding on, and more particularly below, the base 2 so as to be able to penetrate and plug into the receiving support 4 to ensure the anchoring of said base 2 on said support 4.

To that end, said feet may advantageously assume the form of bushings, for example cylindrical bushings with a circular base, advantageously designed to sink at least partially into the fire wall 4B of the vehicle, or more particularly the coating thereof, and each of said feet may have a through screw passage 5 designed to receive an anchoring screw.

To that end, as illustrated in FIGS. 3, 12 and 14, the feet or bushings may more particularly form spacers designed to pass through the carpet 4A covering the floor or fire wall 4B, so as to offset the thickness of said carpet 4A and offer the base 2 a stable seat, bearing directly against said floor or fire wall 4B, that forms a rigid and solid receiving support 4.

According to the invention, the pedal assembly 1 also comprises at least one pedal 6 having an arm 7 that is articulated, here preferably in rotation by a pivot link, on said base 2, around a tilting axis (XX′) supported by said base 2.

The pedal will preferably also include a pad 8, designed to receive a control force F, in principle exerted by the user's foot, capable of driving the tilting and pushing in of the pedal against an actuator 9 of the cable type, or preferably the control rod type, for example for a clutch, accelerator, or preferably a brake.

By convention and to simplify the description, it will be considered that the foreseeable control force F is oriented in the descending direction, and preferably in a substantially vertical direction, as illustrated in FIGS. 1 and 3.

The pad 8, which is preferably wider than the body of the arm 7, may be formed by a curved plate, and will preferably be fixed to or even integral substantially with one of the ends of the arm 7, and more generally the pedal 6, at the upper part of said arm 7.

Said pad 8 may optionally be provided with a non-skid fitting and/or shapes, such as ridges or an elastomer sleeve.

Furthermore, the arm 7 will preferably advantageously include a coupling member 10 designed to receive the end of the actuator 9.

Said coupling member 10 may for example be formed on a transverse circular eyelet, preferably reinforced by ribs, that penetrates inside the body of the arm 7, or even passes through the latter, so as to be able to receive a hook or stirrup present at the end of said actuator 9.

Said coupling member 10 may also be designed to form a ball-joint connector with the end of the actuator 9, for example by forming a spherical bearing in which a spherical end of said actuator snaps.

Of course, any other type of suitable coupling member 10 or equivalent means may be used to functionally, and preferably reversibly, connect the actuator 9 to the arm 7.

In order for the arm 7 to be able to convert the control force F into an actuating force T, and more particularly a compression force, exerted on the actuator 9, while ensuring free access to the pedal, and more particularly to the pad 8, said coupling member 10 will preferably be situated in an intermediate area of the arm closer to the tilting axis (XX′) than the end supporting the pad 8.

The arm 7 may of course assume any suitable shape and dimensions. It may in particular extend generally straight or curved, perpendicular to the tilting axis (XX′) or, on the contrary, obliquely, as in particular illustrated in FIG. 2, so as to axially offset the pad 8 on the abscissa along said tilting axis (XX′), thereby making it off-centered relative to the base 2.

According to the invention, the base 2 includes, between the fastening member 3 and the tilting axis (XX′), a hollow barrel segment 11, generated along a main axis (ZZ′) oriented substantially from said fastening member 3 toward said tilting axis (XX′). The wall 12 of the barrel segment 11 forms, in cross-section transverse to the main axis (ZZ′), a closed contour CF around the main axis (ZZ′), as in particular illustrated in FIGS. 6 and 8 to 10.

Advantageously, the tubular arrangement of the base 2 gives it its lightness, while allowing it in particular, owing to the closed contour CF of its solid wall 12, in at least one straight section normal to the azimuth torsional moment M_{FA}, here substantially yaw around the main axis (ZZ′), that may be generated by the control force F, in particular if said control force is oblique, to preserve the equivalent of a closed frame, passed through by the cavity 24 of the barrel 11 that said closed frame delimits, and preferably substantially centered on the main axis (ZZ′) that said frame contains, said closed frame thereby locally giving the barrel segment 11 a particularly high torsional moment of inertia.

Particularly preferably, the main axis (ZZ′), furthermore preferably substantially rectilinear, is oriented substantially along the foreseeable majority component of the control force F expected under normal usage conditions of the pedal assembly 1, which here corresponds to a substantially vertical orientation, preferably substantially normal to the support 4 on which the base 2 rests and is securely fastened, as is illustrated in FIGS. 1, 3, 5 and 7.

Preferably, the tilting axis (XX′) will be substantially perpendicular to the main axis (ZZ′) of the barrel segment 11.

Additionally, as in particular shown in FIGS. 1 to 4, the arm 7 of the pedal 6 comprises, preferably at its second end, opposite the first end supporting the pad 8, two branches 14 and 15, in this case the left side branch and the right side branch, which form a yoke 16 articulated around the tilting axis (XX′) outside the wall 12 of said barrel segment 11.

Advantageously, such a mounting using a yoke 16 framing the barrel section 11, on either side of the main axis (ZZ′), makes it possible to increase the extent of the pivot link providing the articulation for the pedal 6, and in particular to multiply and distribute the contact surfaces, and more particularly the sliding surfaces of said link, in a balanced manner, or to increase their surface area, without having to alter the size of the barrel segment 11.

The arrangement according to the invention therefore makes it possible to obtain a robust link that benefits from precise guiding and considerably stability, and which is in particular not subject to much deformation or frictional jamming, despite the use of a light, small base with a small bulk and of a limited quantity of material.

Preferably, as illustrated in FIGS. 1 to 3 and 5 to 7, the wall 12 of the barrel segment 11 may have, facing the branches 14, 15 of the yoke 16, substantially parallel flats 17, 18 that are preferably substantially normal to the tilting axis (XX′).

Said flats 17, 18 are preferably axially separated by a separating value that substantially corresponds to the gap of the yoke 16, to within the clearance necessary for tilting.

Advantageously, the branches 14, 15, which in turn are preferably flat and rectilinear, may thus mate said flats 17 and 18, using a contact of the sliding, plane-to-plane type and that is particularly extended and stable, which optimizes the precision and robustness of the guidance of the articulation.

Additionally, such an arrangement allows the barrel segment 11 to form a two-way axial abutment against the branches 14, 15, which makes it possible to move the pedal 6 precisely and avoid any parasitic axial travel, without it being necessary to add ancillary parts such as bushes, spacers, etc.

More generally, the barrel segment 11 may, in transverse cross-section, have a combination of curved wall elements 19, preferably in an arc of circle, and rectilinear planar wall elements, such as the aforementioned flats 17, 18. Such an arrangement may in fact favor not only the reception and guidance of the yoke 16, but also the strength of the base 2, in particular to withstand torsion.

Of course, the shape of the successive section(s) of the barrel segment 11 along the main axis (ZZ′), as well as the shape of the closed contours CF, are in no way limited and may be subject to any number of alternatives without restriction.

Thus, said sections may be curved, and in particular elliptical or circular (FIG. 10), polygonal, regular or irregular, if applicable centered on the main axis (ZZ′), and for example square, rectangular or hexagonal.

Said sections may or may not have one or more axes of symmetry, may or may not have an invariance of rotation of order 2, 3 or higher around the main axis (ZZ′), or may or may not have a geometry of revolution relative to the main axis (ZZ′) that passes through them.

They may lastly combine rectilinear 17, 18 and curvilinear 19 portions, the latter being able to be locally concave or convex.

Furthermore, as illustrated in FIG. 4, each branch 14, 15 of each yoke 16 preferably has a protuberance 20, 21 oriented toward the inside of said yoke 16 to form a joint bearing around the tilting axis (XX′).

Preferably, said protuberances 20, 21 form sorts of cylindrical journals, both with the same dimensions, centered on the tilting axis (XX′).

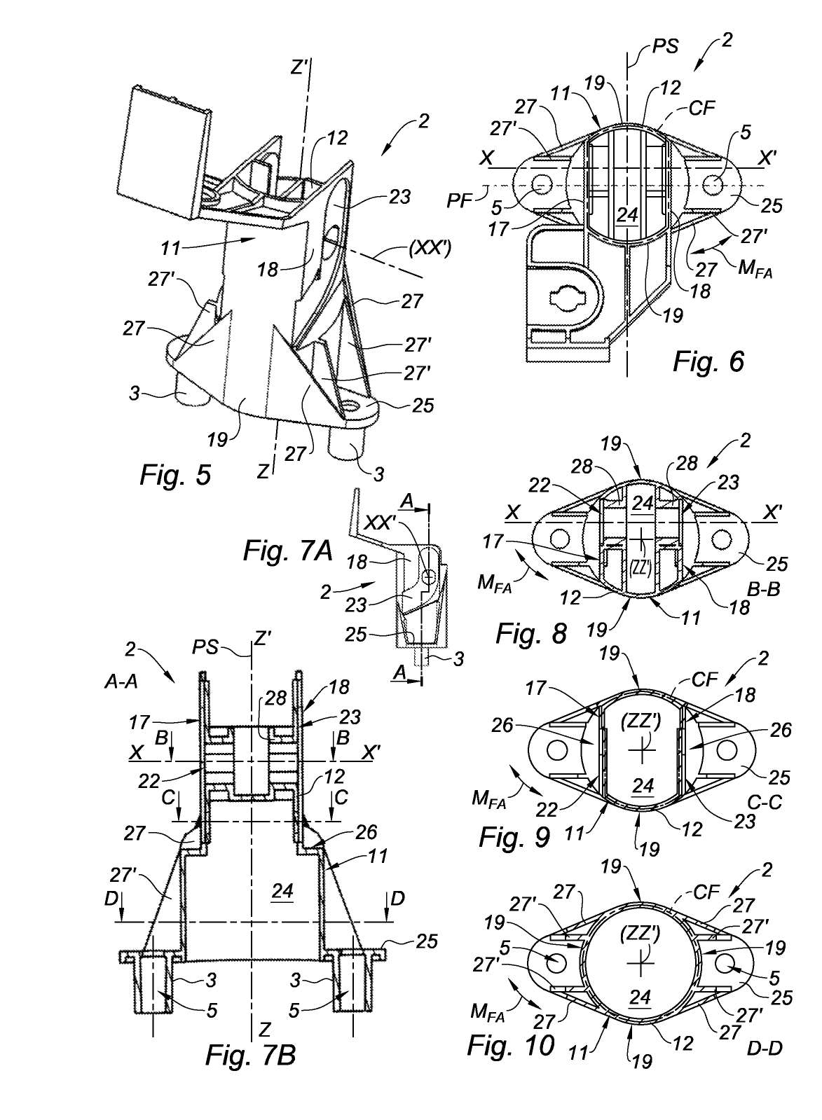

Preferably, as illustrated in FIGS. 1 and 5, each of the left and right outer side portions of the wall of the barrel segment 11, and more particularly each of the flats 17, 18, is also hollowed out by a slot 22, 23 arranged to pass through the tilting axis (XX′) and emerge on at least one of the faces, preferably the front face, of the barrel segment 11, and for example at a lower altitude than that of the tilting axis (XX′), so as to be able to receive the corresponding protuberance 20, 21 of the yoke 16 and guide said protuberance to said tilting axis (XX′) during mounting of the pedal on the base 2.

Advantageously, it is thus possible to assemble the pedal 6 on the base 2 very simply, by frontally bringing the arm 7 closer to the barrel segment 11, substantially perpendicular to the main axis (ZZ′) and the tilting axis (XX′), so as simultaneously to engage both protuberances 20, 21 in the mouth of the respective slots 22, 23, such that the yoke 16 is automatically axially centered along the tilting axis (XX′), then continuing the pushing in movement in front of the pedal 6, allowing said protuberances 20 and 21 to slide along said slots 22 and 23, which thus guide the yoke 16 like rails, until the bores of the branches 14, 15 line up with the bore(s) of the base 2.

The junction between the pedal 6 and the base 2 can then be made simply by introducing, along the tilting axis (XX′), a journal or pin passing through the yoke 16 and the barrel 11 so as to embody said tilting axis (XX′).

According to an alternative embodiment corresponding to that shown in the figures, each slot 22, 23 may for this purpose be substantially in the shape of an L, and comprise a first substantially oblique branch, preferably emerging at a lower level than that of the tilting axis (XX′), i.e., situated, along the main axis (ZZ′), between said tilting axis (XX′) and the fastening members 3, and followed by a second branch, secant to the first branch, said second branch preferably rising substantially along the direction of the main axis (ZZ′) until it reaches or even exceeds the tilting axis (XX).

The width of said slots 22, 23 may decrease along the first branch, like a funnel, while advantageously remaining larger than or equal to the diameter of the protuberances 20, 21, in particular to within the articulation clearance.

Of course, the articulation joint between the pedal 6 and the base 2 is in no way limited to a particular embodiment and may be made using any suitable means, using a simple through pin, or one or more pins, which may swivel into journal bearings or on the contrary be provided with ball bearings or roller bearings, etc.

Furthermore, the hollow barrel segment 11 preferably extends over at least 50%, at least 75%, or even the entire portion of the base 2 comprised between the tilting axis (XX′) and the fastening member 3 that is furthest from the tilting axis (XX′), along the main axis (ZZ′).

Thus, more particularly, the barrel segment 11 preferably extends over at least 50%, or even at least 75%, of the height H0 that separates, along the main axis (ZZ′), the tilting axis (XX′) from the base plane of the base plate 25, normal to said main axis, and therefore from the visible surface of the receiving support 4 on which the base 2 bears, as illustrated in FIG. 3.

If applicable, the barrel segment 11 may continue, so as to extend on either side of the base 2.

In other words, the base 2 may be primarily or completely formed by a hollow column, the barrel segment 11 being open both at its lower base, in the area of the fastening member(s) 3, and at its apex, at or even above the tilting axis (XX′).

Advantageously, such a substantially cylindrical structure having surfaces with open bases is particularly light, and additionally relatively easy to obtain by molding, or even, according to possible alternatives of its geometry that are not shown, by extrusion.

Preferably, as shown in FIGS. 1, 5 to 7, and 11 to 14, the base 2 comprises a plurality of peripheral fastening members 3, 31, 32 distributed around the barrel segment 11, radially beyond the inner cavity 24 delimited by the wall 12 of said barrel segment 11, on a base plate 25 that is transverse with respect to the main axis (ZZ′).

Advantageously, such an arrangement gives the base 2 not only an excellent, stable and balanced seat, in particular owing to the base plate 25, which procures an extended bearing surface against the support 4 that is preferably substantially planar and normal to the main axis (ZZ′), but also great resistance to axial torsion, owing to the significant lever arm given to the anchoring forces by the peripheral distribution of the fastening members 3, 31, 32, which are offset, like satellites, on fins that spread protruding radially relative to the barrel segment 11.

For this purpose, the base plate may adopt any suitable shape, in particular a crown, star, or, as illustrated in the figures, a substantially diamond shape.

Advantageously, the main axis (ZZ′) will pass between the fastening members 3, which will preferably have a regular angular distribution around said axis.

Thus, according to one preferred alternative embodiment, the base 2 will include (exactly) two fastening members 3, attached to two diametrically opposite branches of the base plate 25.

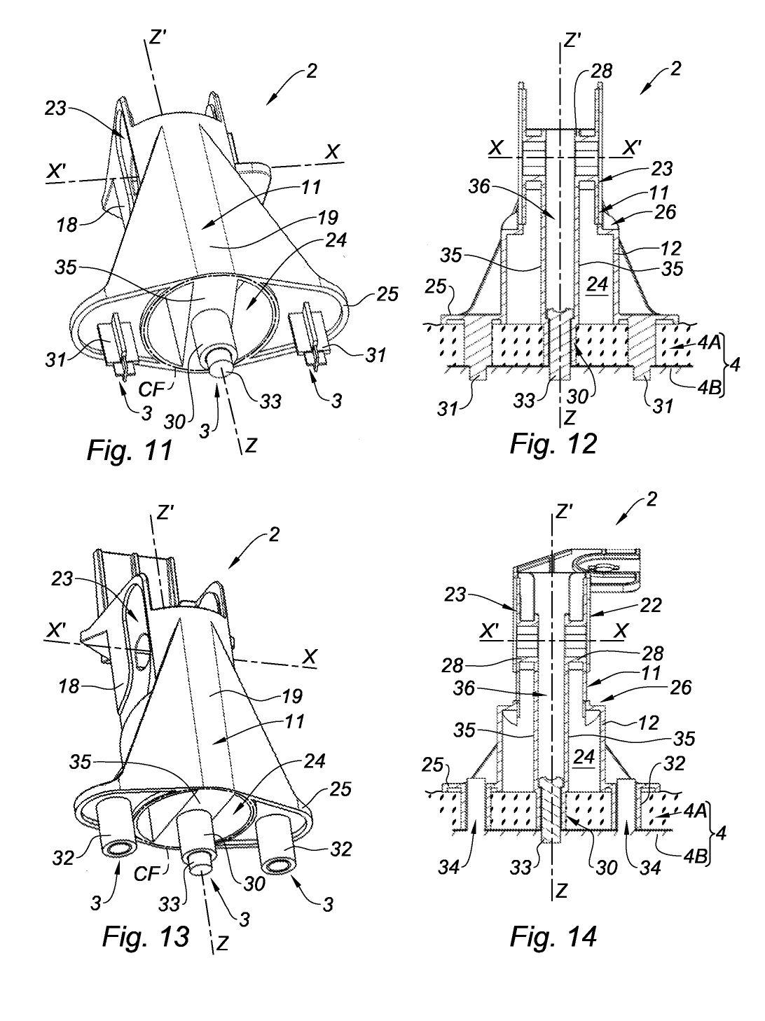

According to other possible alternative embodiments, the base 2 may include at least one central fastening member 30 situated in the inner cavity 24 delimited by the wall 12 of the barrel segment 11, and/or in the extension of said inner cavity 24, as illustrated in FIGS. 11 to 14.

More particularly, the central fastening member 30 may be designed to allow the base 2 to be securely fastened to the receiving support 4, preferably by an anchoring screw 33, while the peripheral fastening members 3 will be formed by one or more pins or crosses 31 (FIGS. 11 and 12), and/or one or more bushings 32 designed to cooperate with centering pins 34 rising on the receiving support 4 (FIGS. 13 and 14).

Said pins, crosses 31 and/or bushings 32 will advantageously allow the base 2 to be positioned angularly relative to the receiving support 4, and to block the azimuth rotation of said base around its main axis (ZZ′).

If applicable, the central fastening member 30 may alone ensure fastening of the base 2, and more particularly the resistance thereof against axial pulling out.

It is of course possible to provide, additionally or alternatively with respect to the preceding alternatives, one or more anti-pitch fastening members 3 placed in front of and/or behind the base 2, rather than laterally, i.e., depthwise toward the arm 7 or across from said arm 7, so as to stabilize said base 2 while opposing the pitch tilting thereof.

It is thus for example possible to have three peripheral fastening points, including two left and right side points and one frontal or dorsal point.

The base plate 25 will also preferably be situated at the lower end of the base 2, and more particularly at the open base of the barrel segment 11.

The base plate 25 may furthermore advantageously be formed in a single piece with said barrel segment 11.

Furthermore, whatever their number, the fastening members 3 may form feet, of the bushing type, that protrude below the base plate 25, across from the barrel segment 11, and whereof the passage hole 5 for screws 33 will preferably follow a direction substantially parallel to the direction of the main axis (ZZ′) of the barrel segment 11.

Such an arrangement in particular makes it possible to have a primarily, or even exclusively, tensile stress (traction) applied to the base 2 as a reaction R to the control F forces and actuating T forces, and more particularly compression forces on the actuator 9, that are transmitted by the arm 7.

If applicable, in particular if they extend perpendicular to the lower face of the base plate 25, the fastening feet 3 may be supported by reinforcing ribs, as indicated in FIG. 3.

According to one preferred arrangement, as illustrated in FIG. 3, projected in a plane, here a sagittal plane PS, normal to the tilting axis (XX′), one and/or the other of the fastening members 3, and preferably all of said fastening members 3, may be positioned substantially in the axial extension of the barrel segment 11, offset relative to the tilting axis (XX′), which here overhangs the considered fastening member(s), either toward the arm 7 of the pedal 6, as illustrated in FIG. 3, or away from said arm 7.

The direction of this offset, here forward or backward by convention, will be chosen such that the force line L passing through the fastening member 3 and the tilting axis (XX′) substantially follows the orientation of the foreseeable reaction R of the base 2 to the foreseeable forces, on the one hand the control force F, that control force F being exerted by the user on the arm 7, and on the other hand the actuating force T, that actuating force T being exerted by the arm on an actuator 7 of the brake control rod type, to which said arm 7 is designed to be connected.

Thus, this offset between the application point of the reaction R of the base 2 on the arm 7 (at the tilting axis XX′) and the application point of the maintaining force exerted by the support 4 on said base 2 (at the fastening feet 3) advantageously makes it possible to trace a fictitious force line L between said two points, said line preferably being substantially parallel to the foreseeable direction of the reaction R, in light of the nature and orientation of the anticipated control force F.

This arrangement, with frontal offset, here in the forward direction, of the fastening members 3 relative to the tilting axis (XX′), toward the pad 8, thus makes it possible to apply to the base 2, and more particularly to the barrel segment 11, an essentially or even exclusively traction-type load, in a direction and with a stress scheme that may advantageously coincide with the optimal load strength conditions of said base 2, and more particularly of the barrel segment 11.

It is thus possible to minimize the amount of material necessary to form the base 2, and consequently to lighten the latter.

Furthermore, the risk of shearing of the anchoring screw(s) 33 ensuring fastening of the base plate 25 on the fire wall 4B of the vehicle is thus limited.

Purely for information, the incline angle value α of the force line L relative to the main axis (ZZ′), and more generally relative to the vertical, and/or relative to the normal to the support 4, may be substantially comprised between −50 degrees and +50 degrees, between −30 degrees and +30 degrees, or preferably between −5 degrees and +5 degrees.

According to one preferred alternative embodiment, the base 2, and preferably the barrel segment 11, has a transverse section that increases going from the tilting axis (XX′) toward the fastening member(s) 3.

The section of said barrel segment 11, and more particularly the diameter of the inner cavity 24, and therefore the radial seat of the wall 12, may thus increase, here along decreasing ordinates (ZZ′), either gradually and continuously, or by steps, in particular at one or more successive widening shoulders 26, as illustrated in FIGS. 7B, 12 and 14.

Such an arrangement makes it possible to give the base 2 a widened base, which gives the “mast” formed by the barrel segment 11 a better hold on the base plate 25 and the support 4, and therefore better stability, as well as a torsional moment of inertia that increases as one comes closer to the embedding procured by the fastening members 3.

Furthermore, this widening and stiffening of the base 2 may be accentuated by outer reinforcing ribs 27, which are preferably triangular and substantially vertical, that support and anchor the barrel segment 11 and the base plate 25, preferably from the sides of the diamond formed by the base plate 25.

If applicable, it is thus possible to provide several sets of ribs 27, 27′, including primary ribs 27, following the sides of said diamond, and intermediate secondary ribs 27′, secant thereto and bordering the screw passages 5, parallel to the base's frontal plane PF that contains the main axis (ZZ′) and that is parallel to the tilting axis (XX′).

According to another alternative embodiment, as a complement or alternative to the preceding embodiments, the base 2, and more particularly the barrel segment 11, may be reinforced by inner reinforcing ribs 35, for example forming one or more crossbeams, preferably positioned diametrically inside the cavity 24, and for example substantially transverse, or perpendicular, to the outer ribs 27, 27′, as illustrated in FIGS. 11 to 14.

If applicable, at least one pair of such inner ribs 35, substantially parallel to the main axis (ZZ′), here vertical in FIGS. 12 and 14, may delimit a conduit 36, here emerging at the apex of the base 2, said conduit offering access to the central fastening member 30 so as to allow inserting and operating of the anchoring screw 33.

Furthermore, as shown in FIGS. 7 and 8, the barrel segment 11 preferably has an inner narrowing 28 that marks an overthickness of its wall 12 and that is pierced all the way through so as to offer a bearing for the tilting axis (XX′).

Advantageously, this material mass located near the tilting axis (XX′), occupying or even completely or partially obstructing the cavity 24 of the barrel 11, and advantageously pierced with a bore emerging perpendicular to the main axis (ZZ′), imparts increased mechanical strength and a maximized contact surface to the axis bearing formed by said bore, which may advantageously be used raw as a journal bearing.

Thus being, the thickness of the wall 12 may furthermore be substantially constant, along the main axis (ZZ′), over the rest of the barrel segment 11.

It will furthermore be noted that, irrespective of the considered characteristic or combination of characteristics, in particular among the arrangement of the barrel segment 11, its wall 12, slots 22, 23, reinforcing ribs 27, 27′, 35, the base plate 25 or fastening members 3, the base 2 will preferably have a planar symmetry (here left-right symmetry) relative to the median plane, or sagittal plane PS, which is normal to the tilting axis (XX′) and contains the main axis (ZZ′).

Furthermore, although it is not ruled out for the pedal assembly 1 to be made in whole or in part from metal materials, in particular light alloys, for example aluminum-based alloys, the base 2 and/or the pedal 6 may preferably be made integrally, and preferably in a single piece, from a polymer material, optionally reinforced with fibers.

Advantageously, the high structural strength of the pedal assembly 1 with respect to stresses generated by the control force F makes it indeed possible to use light polymer materials without jeopardizing the robustness or reliability of the operation of said pedal assembly.

Preferably, the base 2 and/or the pedal 6 is (are) made integrally, and preferably in a single piece, from a material that can be injection molded.

More particularly, the material that can be injection molded may be chosen from among: a thermoplastic polymer, a composite material having a matrix made from a plastic and that may or may not be reinforced by woven or not woven fibers, and an aluminum- or magnesium-based metal alloy.

Thus, the component elements of said pedal assembly may be manufactured in particular using injection molding methods, which are quick and inexpensive, making it possible to save on raw materials and energy.

According to one possible alternative embodiment, the pedal assembly may be made in whole or in part by assembling sheets of aluminum or steel, or rigid plates of composite materials having a matrix made from plastic, and preferably the base 2 and/or the pedal 3 may be made, by assembling sheets of aluminum or steel, or rigid plates made from composite materials having a matrix made from plastic.

Furthermore, as mentioned above, the pedal assembly may advantageously be formed, according to one particularly simplified alternative embodiment, by only three elements, namely a base, a pedal and a pin (not shown), made from metal or plastic, embodying the tilting axis.

According to this configuration, said pin may be forcibly fitted in the yoke and may directly swivelin the bore of the base forming a journal bearing, with suitable guidance clearance, or vice versa, be forcibly fitted in the base to be fastened therein, passing axially through the yoke 16, and allow the free rotation of said yoke around said pin.

Of course, the invention is not limited to one particular alternative embodiment, one skilled in the art in particular being able to adapt, isolate or combine one or more of the aforementioned features. In particular, it would for example be possible to consider the pedal assembly controlling the actuator in traction rather than compression.

Lastly, it will easily be understood that the invention may also relate, as such, to a method for manufacturing and assembling a pedal assembly, according to any of the alternatives described above.

1. A pedal assembly comprising a base provided with at least one fastening member designed to allow said base to be fastened on a receiving support, such as the fire wall of a vehicle, as well as at least one pedal having an arm that is articulated on said base around a tilting axis supported by said base, wherein the base includes, between said at least one fastening member and the tilting axis, a hollow barrel segment created along a main axis oriented substantially from said fastening member toward said tilting axis, the wall of the barrel segment forming, in transverse cross-section relative to the main axis, a closed contour around the main axis, and in that the arm of the pedal comprises two branches forming a yoke that is articulated around the tilting axis outside the wall of said barrel segment.

2. The pedal assembly according to claim 1, wherein the barrel segment extends over at least 50% of the base comprised between the tilting axis WO and the fastening member furthest therefrom.

3. The pedal assembly according to claim 1, wherein the base comprises a plurality of peripheral fastening members distributed around the barrel segment, radially beyond the inner cavity delimited by the wall of said barrel segment, on a base plate transverse to the main axis.

4. The pedal assembly according to claim 1, wherein the base includes at least one central fastening member situated in the inner cavity delimited by the wall of the barrel section and/or in the extension of said inner cavity.

5. The pedal assembly according to claim 3, wherein the central fastening member is designed to allow the base to be securely fastened to the receiving support, preferably by an anchoring screw, while the peripheral fastening members are formed by one or more pins or crosses, and/or one or more bushings designed to cooperate with centering pins rising on the receiving support, so as to position the base regularly relative to the receiving support and block the azimuth rotation of said base around its main axis.

6. The pedal assembly according to claim 1, wherein the base, and the barrel segment, has a transverse section that increases going from the tilting axis WO toward the fastening member(s).

7. The pedal assembly according to claim 1, wherein the barrel segment has an inner narrowing that marks an overthickness of the wall of said barrel segment and that is pierced all the way through so as to form a bearing for the tilting axis.

8. The pedal assembly according to claim 1, wherein projected in a plane normal to the tilting axis, at least one fastening member is positioned substantially in the axial extension of the barrel segment, offset relative to the tilting axis, either toward the arm or at the opposite from said arm, such that the force line passing through said fastening member and said tilting axis substantially follows the orientation of the foreseeable reaction of the base to the foreseeable control forces, to be exerted by the user on the arm, and to the foreseeable actuating forces, to be exerted by the arm on an actuator of the brake control rod type, to which said arm is designed to be connected.

9. The pedal assembly according to claim 1, wherein each branch of the yoke has a protuberance oriented toward the inside of said yoke to form a joint bearing around the tilting axis, and in that each of the left and right outer side portions (17,18) of the wall of the barrel segment is hollowed out with a slot arranged to pass through the tilting axis and emerge on at least one of the faces, preferably the front face, of the barrel segment, so as to be able to receive the corresponding protuberance of the yoke and guide it to said tilting axis during mounting of the pedal on the base.

10. The pedal assembly according to claim 1, wherein the base and/or the pedal are made integrally, and preferably in a single piece, from a material that can be injection molded.

11. The pedal assembly according to claim 10, wherein the material that can be injection molded is selected from among: a thermoplastic polymer, a composite material having a matrix made from a plastic and that may or may not be reinforced by woven or not woven fibers, and an aluminum- or magnesium-based metal alloy.

12. The pedal assembly according to claim 1, wherein the pedal assembly is made in whole or in part by assembling sheets of aluminum or steel, or rigid plates of composite materials having a matrix made from plastic, and preferably in that the base (2) and/or the pedal are made, by assembling sheets of aluminum or steel, or rigid plates of composite materials having a matrix made from plastic.

13. A vehicle, in particular a motor vehicle, equipped with a pedal assembly according to claim 1.
